(19) United States
(12) Patent Application Publication
(10) Pub. No.: US 2016/0346687 A1
(43) Pub. Date: Dec. 1, 2016

(54) Online Game Having a Computerized Recommender System

(71) Applicant: Jagex Limited, Cambridge (GB)

(72) Inventors: Samuel Claude Kerrien, Preverenges (CH); Simon Forester Worgan, Cambridge (GB)

(21) Appl. No.: 15/164,843

(22) Filed: May 25, 2016

(30) Foreign Application Priority Data
May 26, 2015 (GB) 1508921.2
May 26, 2015 (GB) 1508923.8
May 26, 2015 (GB) 1508924.6
May 26, 2015 (GB) 1508926.1

(51) Int. Cl. A63F 13/35; A63F 13/335

(52) U.S. Cl. CPC A63F 13/35; A63F 13/335; A63F 2300/807; A63F 2300/407

(57) ABSTRACT

An online game system is described that is configured to provide at least one recommendation in an online game for a single user of a plurality of users of the online game by: ranking, based on desirability of at least some of the plurality of users' past behavior within the online game, mutually preferred sets of sequences of in-game activities previously carried out by at least some of the plurality of users of the online game and sets of sequences of in-game activities available at locations within the online game; and providing at least one recommendation to the single user based on the ranking.

### RELATED APPLICATIONS

This application claims priority for Application GB1508921.2 filed on May 26, 2015. This application claims priority for Application GB1508923.8 filed on May 26, 2015. This application claims priority for Application GB1508924.6 filed on May 26, 2015. This application claims priority for Application GB1508926.1 filed on May 26, 2015. All of which are incorporated herein in their entirety.

### FIELD OF THE INVENTION

The present invention relates to a computerized recommender system for an online game and particularly a massively multiplayer online role playing game.

### BACKGROUND OF THE INVENTION

Massively multi-player online games (MMOGs) are online video games capable of supporting large numbers of players simultaneously. MMOG servers may support hundreds, thousands or even more players.

MMOG use has grown significantly over the last decade, with some games having millions of active users. One example of an MMOG is RuneScape (registered trade mark), developed and published by Jagex Limited, Cambridge, United Kingdom. RuneScape has over 200 million registered accounts and often has in excess of 500,000 users per day, with servers often supporting thousands of players simultaneously. The amount of bandwidth and processing power needed to support MMOGs can therefore be huge.

While many types of MMOG exist, most are role-playing games or massively multiplayer online role playing games (MMORPGs) such as RuneScape. MMORPGs are often set in complex virtual worlds that continue to exist even when a player is not actually online playing the game. Players typically create a character or ‘avatar’ that exists in the virtual world and that has skills or traits that the players can develop. Players may be able to interact and communicate with each other, complete quests and tasks to meet game objectives and obtain rewards, and may collaborate with or compete against other players. Unlike most other gaming genres, MMOGs are usually open-ended with no absolute endpoint, and game developers frequently add new content to their games.

Developers generate revenue through MMOGs in a variety in ways. Some games require a paid subscription, while others are free to play. Some rely entirely or mostly on advertising revenue, and some generate revenue through in-game transactions, as these are typically of low monetary value they are often called microtransactions. In each microtransaction, a user exchanges real money for virtual goods such as in-game currency, items, bonuses or new content. Regardless of their means of revenue, it is in the interest of the developers to keep their users playing their games.

Developers can keep users interested by releasing new and exciting content. Additionally, developers may try to promote content or behavior that is likely to result in a user spending more time playing the game, or that is likely to result in a user spending more money on in-game transactions. Developers may wish to promote such content or behavior at a population level, or at an individual, personalized level.

Predicting which new content will appeal to a significant part of the user population or predicting content to promote to an individual user is inherently difficult. By their very nature, MMOGs have a vast number of users, and users have diverse preferences and playing patterns. Further, due to the complex nature of the virtual worlds that are common to MMOGs, the amount of data that the games generate is huge and the data is complex. This makes analyzing the data very difficult. A need therefore exists for systems that can use the data generated by MMOGs to predict content that will appeal to users, both at a population level and an individual level.

Recommender systems (also known as recommendation systems) are information filtering systems that predict user preferences to try to predict content what will appeal to users. The intention of this is to, for example, to keep them playing a game longer and/or carry out more in-game transactions. The content that is predicted may include a special task to carry out for a reward for example in virtual currency.

Known recommender systems are based on individual users' previous gaming activity. Known recommender systems also base their recommendations on the activity of other users, especially users who the system deems to have similar preferences to a particular target user.

One approach used to implement recommender systems is collaborative filtering. Collaborative filtering involves collecting and analyzing large amounts of user data from multiple users. Rather than relying on the actual meaning of past user behavior, collaborative filtering seeks to establish patterns, and assumes that users with similar past preferences will have similar future preferences. The system can then recommend content to a user that was of interest to another user with similar preferences.

A second approach used to implement recommender systems is content-based filtering. Content-based recommender systems use data to determine attributes that apply to a user (for example, using preferences indicated by a user), and then recommend content that somehow shares those attributes.

Recommender systems may make use of both collaborative and content-based filtering to deliver relevant content to a user.

U.S. Pat. No. 8,028,022 assigned to IBM describes a recommender system in which a list of potential recommendations is required to be generated from the user's immediate social network and for the final recommendation to be explicitly selected by the targeted individual.

A similar in-game recommendation approach is described in US patent application with publication No. 2009-0197681 assigned to Microsoft, which does not require explicit user feedback as described in U.S. Pat. No. 8,028,022 but still requires an explicit social connection between the source and the target of the recommendation.

Known recommender systems for MMOGs are computer resource intensive, requiring large amounts of computer processor and memory resources.

Known recommender systems for MMOGs often give poor recommendations to players by, for example, recommending content that is not desirable to the user; recommending content in an untimely manner, for example, at a time during a user's game when they are already involved in trying to complete a task, or recommending too much content so that, for example, the user is so overwhelmed with possibilities they ignore the content.

### BRIEF SUMMARY OF THE INVENTION

Examples of the arrangements described herein address the technical problems of the known recommender systems described above.

The invention in its various aspects is defined in the independent claims below to which reference should now be made. Advantageous features are set forth in the dependent claims.

Arrangements described herein integrate a recommender system with an online game, enabling it to deliver personalized content recommendations in real-time.

In the arrangements described herein, the recommender system analyses sequences of in-game event data points and recommends which game content a player should play next. The in-game event data points are captured from player actions. These recommendations are derived from the previous behavior of other players. The recommendations are designed to optimize business relevant metrics (such as increasing revenue or time spent playing the game). This is achieved by observing game events that correlate with some desired outcome. When an individual is observed who appears to be following a similar pattern, an attempt is made to guide them down a similar path by recommending the remaining actions. Game events can be very low level, for example, a ‘variable x changing from 7 to 16 at coordinate x,y,z at time t’. Alternatively, game events may be defined as more easily human-understandable high level concepts such as “chopping down a tree”. Arrangements described herein use these low level and high level events to generate human-readable gameplay recommendations that are integrated with a MMOG and delivered to players.

This approach moves away from the personal and direct recommendation of inventory, for example, songs or in-stock items, and instead recommends continuous in-game content to optimize an implicit target, for example, revenue or engagement.

As described above, known recommender systems typically work through a process of collaborative filtering whereby individuals are matched to similar users and presented with the items that they have not purchased but the matched users have.

The inventors of the present application have appreciated that instead of forming weighted connections between people who are users of a MMOG and items, that is, activities carried out on the MMOG as in the known MMOG collaborative and content based recommender systems described above, each user and item may be defined as a feature set and weighted connections and, in particular, bi-directional weighted connections or mutual preferences may be formed between them.

The bi-directional weighted connections between features provide the advantage that both the user's preference for the entity and the entities preference for the user can be expressed. In other words, their mutual preferences are taken into account. For example, a penniless student may prefer a red Ferrari but a red Ferrari prefers a rich racing driver. This results in the provision of good recommendations that are computationally efficient to generate in an MMOG environment.

This is in contrast to the known arrangements of the types described in U.S. Pat. No. 8,028,022 and in US patent application with publication No. 2009-0197681 summarized above.

In embodiments of the present invention, the recommendation set is inferred from implicit behavioral similarities and delivers the recommendation according to the users live in-game actions. Accordingly, the embodiments of the present invention do not require an explicit social network or direct user feedback. The inference of behavioral similarities replaces both of these requirements.

In embodiments of the present invention, the ideal recommendation is inferred from the aggregated information of the entire player base and the arrangement is not constrained to individual, socially connected, recommendation sources.

Embodiments of the invention also provide for each feature being split into ‘more desirable’ and ‘less desirable’ distributions. These distributions capture whether or not the realized value of a feature leads to a desired outcome, those that did contribute belong to the ‘more desirable’ distribution and those that did not contribute belong to the ‘less desirable’ distribution.

In an aspect of the present invention, there is provided an online game system configured to provide at least one recommendation in an online game for a single user of a plurality of users of the online game by: ranking, based on desirability of the user's past behavior within the online game, mutually preferred sets of sequences of in-game activities previously carried out by the user and sets of sequences of in-game activities available at locations within the online game; and providing at least one recommendation based on the ranking. This system computationally efficiently provides effective recommendations for a large population playing an online game. The desirability of the user's past behavior may comprise at least one of: time in-game by the user and spend in-game by the user. The at least one recommendation may comprise at least one location for the user to go to in-game. The at least one recommendation may comprise at least one activity for that user to carry out in-game.

The sets of sequences of in-game activities may comprise generalized sets of sequences of in-game activities. This allows the system to effectively draw recommendations from large inventories.

Each user may have an associated set of user features. The at least one recommendation may comprise a set of recommended in-game locations. The system may be configured to provide a ranking of sequences of in-game activities associated with each recommended location according to the mutual preference between the sequences of in-game activities associated with each recommended location and the set of user features for the single user, and to select a plurality of sequences of in-game activities according to the ranking to provide a set of location-activity sequence pairs for the single user.

The frequency by which at least some of the plurality of users carry out sequences of in-game activities may be provided by a mathematical distribution function, such as a Poisson distribution. The frequency by which at least some of the plurality of users carry out sequences of in-game activities at a particular location is provided by a mathematical distribution function, such as a Poisson distribution. The frequency by which at least some of the plurality of users are at a particular location of the online game may be provided by a mathematical distribution function, such as a Poisson distribution. The mathematical distribution function may comprise at least one parameter defining the distribution function. The at least one parameter may be selected by iteration. The iteration may comprise iterating each parameter separately. The iteration may comprise no more than 3 to 5 iterations. The iteration may comprise exactly 3, exactly 4 or exactly 5 iterations. The ranking may be based on an optimized combination of mathematical distribution functions. The users, locations and sequences may be represented as human-readable text. The human-readable text may comprise JavaScript Object Notation, JSON.

In an aspect of the present invention, there is provided a method for providing recommendations in an online game to a single user of a plurality of users of the online game, comprising: ranking, based on desirability of the user's past behavior within the online game, mutually preferred sets of sequences of in-game activities previously carried out by the user and sets of sequences of in-game activities available at locations within the online game; and providing at least one recommendation based on the ranking.

The desirability of the user's past behavior comprises at least one of: time in-game by the user and spend in-game by the user. The at least one recommendation may comprise at least one location for the user to go to in-game. The at least one recommendation may comprise at least one activity for the user to carry out in-game. The sets of sequences of in-game activities may comprise generalized sets of sequences of in-game activities.

Each user may have an associated set of user features. The at least one recommendation may comprise a set of recommended in-game locations. The method may comprise ranking sequences of in-game activities associated with each recommended location according to the mutual preference between the sequences of in-game activities associated with each recommended location and the set of user features for the single user, and selecting a plurality of sequences of in-game activities according to the ranking to provide a set of location-activity sequence pairs for the single user.

The frequency by which at least some of the plurality of users carry out sequences of in-game activities may be provided by a mathematical distribution function, such as a Poisson distribution. The frequency by which at least some of the plurality of users carry out sequences of in-game activities at a particular location may be provided by a mathematical distribution function, such as a Poisson distribution. The frequency by which at least some of the plurality of users are at a particular location of the online game may be provided by a mathematical distribution function, such as a Poisson distribution. The mathematical distribution function may comprise at least one parameter defining the distribution function. The at least one parameter may be optimized by iteration. The iteration may comprise iterating each parameter separately. The iteration may comprise no more than 3 to 5 iterations. The iteration may comprise exactly 3, exactly 4 or exactly 5 iterations. The ranking may be based on an optimized combination of mathematical distribution functions. The users, locations and sequences may be represented as human-readable text. The human-readable text may comprise JavaScript Object Notation, JSON.

In one aspect of the invention, there is provided an online game system for a plurality of users, comprising one or more game servers hosting an online game and a computerized recommender system connected to the one or more game servers for providing recommendations in the online game;

the computerized recommender system being configured to:

for each of a plurality of recommended actions, determine preceding user actions that lead to that recommended action to generate a set of user action/recommendation pairs;

produce a reduced set of user action/recommendation pairs from the set of user actions by removing user action/recommendation pairs having an equivalent action/recommendation pair within the set of user action/recommendation pairs; and

identify the most frequently occurring user action/recommendation pairs from those user action/recommendation pairs within the reduced set of user action/recommendation pairs to form a set of rules for providing recommendations within the online game;

the one or more game servers being configured to deliver recommendations to users of the online game based on the set of rules and on actions taken by the users within the online game.

This approach means that the recommendations are delivered as immediately relevant activities within the game, based on the real-time activity of the user.

Successful MMOGs may have many thousands of players playing the game each day. This aspect of the invention allows triggering rules for determining when to deliver recommendations to be determined for the whole population of users in a way that accounts for user behavior in the game but which is computationally achievable. Reducing the user action recommendation pairs by treating some action/recommendation pairs as equivalent to one another reduces the amount of computation required when determining when to deliver a recommendation but ensures that a significant number of recommendations are still delivered.

On a typical day the successful online game system, RuneScape, will evaluate the connections between 4934 in game locations, 16,769 actions and 5404 users. If this evaluation is done exhaustively the system would have to consider 1.2×10¹⁶ connections [users×(sequences+locations)×(sequences+users)×locations]. By comparison Facebook has to handle 1.4×10¹⁴ connections, two orders of magnitude less. So it is clear that computational efficiency and a reduction in the amount data being processed to provide recommendation is critical.

In one embodiment, the user actions comprise sets of user events, and the computerized recommender system is configured to categorize user actions comprising the same user events in different order as equivalent user actions. The sets of user events may comprise events occurring at the same game location or within a predetermined time period.

The computerized recommender system may further be configured to: rank the rules in the set of rules based on predicted impact of the recommendation in the online game; select highest ranked rules; and output the selected highest ranked rules as a set of generic rules for the online game. This ensures that only recommendations that lead to a significant impact in the game are delivered. The impact may be an increase in user game time or an increase in user spend within the game, for example.

The one or more game servers may be configured to: compare a single user's actions with the set of generic rules and if the user's actions correspond to one of the generic rules, provide a generic recommendation corresponding to that generic rule; compare the generic recommendation with a ranked list of recommendations for the single user; and deliver to the user the generic recommendation if it is also present in the ranked list of recommendations for the single user. This ensures that the recommendations delivered to each user are both relevant to the immediately preceding user activity within the game and personal to the user. The ranked list of recommendations for the single user may be derived from the user's history or recent history within the game. In other words, this approach combines personalization based on an offline analysis of the user's long-term play patterns and relevance by triggering recommendations in real-time, in response to the immediate events of their current play session.

If the single user's actions correspond to a plurality of the generic rules that are present in the ranked list of recommendations for the single user, then the one or more game servers may be further configured to: provide a generic recommendations corresponding to each of the corresponding generic rules; compare the generic recommendations with the ranked list of recommendations for the single user; and deliver to the user the generic recommendation that corresponds is the highest ranked in the ranked list of recommendations for the single user. In this way, the personally relevant recommendation leading to the highest impact within the game is delivered to the user.

The single user's ranked list of recommendations may be based on recent activity in the game. The single user's ranked list of recommendations may be ranked according based on predicted impact within the game.

The recommender system may be configured to update the ranked list of recommendations for the single user if and only if the single user has used the online game since a most recent update.

The recommender system may be configured to export an updated user specific recommendations data set to the game server based on users' in-game activity, and the game server may be configured to switch from a current user specific recommendations data set to the updated user specific recommendations data set after the updated user specific recommendations data set has been exported to the game server. This aspect of the invention ensures that the process of updating recommendations has minimal impact of the operation of the game and in particular on the experience of the users of the game.

The updated user specific recommendations data set may differ from the current user specific recommendations data set only for those users that have used the online game since the export of the current user specific recommendations data set.

In another aspect of the invention, there is provided an online game system configured to provide recommendations in an online game for a plurality of users, comprising one or more game servers connected to a computerized recommender system, the computerized recommender system being configured to:

monitor users actions within the online game;

observe desired outcomes within the game following particular users actions;

sort the users actions that led to the desired outcomes into groups of equivalent user actions;

and, form a set of rules based on the mostly frequently occurring groups of users actions that led to the desired outcomes;

the one or more game servers being configured to deliver recommendations to users based on the set of rules.

In a further aspect of the invention, there is provided a method for providing recommendations to users of an online game system for a plurality of users, the online game system comprising one or more game servers hosting an online game, comprising:

for each of a plurality of recommended actions, determining preceding user actions that lead to that recommended action to generate a set of user action/recommendation pairs;

producing a reduced set of user action/recommendation pairs from the set of user actions by removing user action/recommendation pairs having an equivalent action/recommendation pair within the set of user action/recommendation pairs; and

identifying the most frequently occurring user action/recommendation pairs from those user action/recommendation pairs within the reduced set of user action/recommendation pairs to form a set of rules for providing recommendations within the online game; and

delivering the set of rules to the one of more game servers so that recommendations can be delivered to users of the online game based on the set of rules and on actions taken by the users within the online game.

The user actions may comprise sets of user events, and further comprising: categorizing user actions comprising the same user events in different order as equivalent user actions.

The sets of user events may comprise events occurring at the same game location or within a predetermined time period.

The method may further comprise: ranking the rules in the set of rules based on predicted impact of the recommendation in the online game; and selecting highest ranked rules; wherein the step of delivering comprises delivering the selected highest ranked rules as a set of generic rules for the online game.

The method may further comprise: comparing a single user's actions with the set of generic rules and if the user's actions correspond to one of the generic rules, provide a generic recommendation corresponding to that generic rule; comparing the generic recommendation with a ranked list of recommendations for the single user; and delivering to the user the generic recommendation if it is also present in the ranked list of recommendations for the single user.

In one embodiment, the method may comprise, if the single user's actions correspond to a plurality of the generic rules that are present in the ranked list of recommendations for the single user, then: providing a generic recommendations corresponding to each of the corresponding generic rules; comparing the generic recommendations with the ranked list of recommendations for the single user; and delivering to the user the generic recommendation that corresponds is the highest ranked in the ranked list of recommendations for the single user.

The single user's list of recommendations may be based on recent activity in the game. The single user's list of recommendations may be ranked based on predicted impact within the game.

The method may comprise updating the ranked list of recommendations for the single user if and only if the single user has used the online game since a most recent update.

The method may comprise exporting an updated user specific recommendations data set to the game server based on users' in-game activity, and in the game server switching from a current user specific recommendations data set to the updated user specific recommendations data set after the updated user specific recommendations data set has been exported to the game server. The updated user specific recommendations data set may differ from the current user specific recommendations data set only for those users that have used the online game since the export of the current user specific recommendations data set.

In another aspect of the invention, there is provided an online game system configured to providing recommendations in an online game to a single user of a plurality of users of the online game, the game system being configured to:

compare a ranked list of recommendations for the single user with a generic recommendation taken from a ranked list of generic recommendations for the plurality of users; and

deliver the generic recommendation if it is on the ranked list of recommendations for the single user.

The single user's list of recommendations may be based on recent activity in the game. The single user's list of recommendations is ranked based on predicted impact within the game. Impact in this context may be an increase in user game time or an increase in user spending within the game, for example.

The computerized recommender system is preferably further configured to provide the generic recommendation based on the single user's current actions within the game. This means that recommendations delivered to the user are directly related to and triggered by their current activity.

This aspect of the invention ensures that the recommendations delivered to each user are both relevant to the immediately preceding user activity within the game and personal to the user. The ranked list of recommendations for the single user may be derived from the user's history or recent history within the game. In other words, this approach combines personalization based on an offline analysis of the user's long-term play patterns and relevance by triggering recommendations in real-time, in response to the immediate events of their current play session.

The system may further be configured to provide the generic recommendation based on a set of generic rules; wherein each of the rules links a single user's actions with a generic recommendation. The computerized recommender system may be configured to generate the set of generic rules based on a group of most frequent users' actions that lead to desired outcomes within the game.

The system may be configured to select the rules in the set of generic rules from a wider set of rules based on a predicted impact of the desired outcomes in the online game. For example, the wider set of rules may be ranked based on predicted impact of the desired outcomes in the online game, and the top 30 rules from the ranked wider set of rules may form the set of generic rules.

The recommender system may be configured to update the ranked list of recommendations for the single user if and only if the single user has used the online game since a most recent update.

The recommender system may be configured to export an updated user specific recommendations data set to the game server based on users' in-game activity, and the game server may be configured to switch from a current user specific recommendations data set to the updated user specific recommendations data set after the updated user specific recommendations data set has been exported to the game server. This aspect of the invention ensures that the process of updating recommendations has minimal impact of the operation of the game and in particular on the experience of the users of the game.

The updated user specific recommendations data set may differ from the current user specific recommendations data set only for those users that have used the online game since the export of the current user specific recommendations data set.

In another aspect of the invention, there is provided a method for providing recommendations in an online game to a single user of a plurality of users of the online game, comprising:

comparing a ranked list of recommendations for the single user with a generic recommendation taken from a ranked list of generic recommendations for the plurality of users; and

delivering the generic recommendation if it is on the ranked list of recommendations for the single user.

The single user's list of recommendations may be based on recent activity in the game. The single user's list of recommendations may be ranked based on predicted impact within the game.

The method may further comprise providing the generic recommendation based on the single user's actions within the game. The method may further comprise providing the generic recommendation based on a set of generic rules; wherein each of the rules links a single user's actions with a generic recommendation. The method may comprise generating the set of generic rules based on a group of most frequent users' actions that lead to desired outcomes within the game. The method may comprise selecting the rules in the set of generic rules from a wider set of rules based on a predicted impact of the desired outcomes in the online game.

The method may comprise updating the ranked list of recommendations for the single user if and only if the single user has used the online game since a most recent update.

The method may comprise exporting an updated user specific recommendations data set to the game server based on users' in-game activity, and in the game server switching from a current user specific recommendations data set to the updated user specific recommendations data set after the updated user specific recommendations data set has been exported to the game server. The updated user specific recommendations data set may differ from the current user specific recommendations data set only for those users that have used the online game since the export of the current user specific recommendations data set.

In another aspect of the invention, there is provided an online game system comprising a game server hosting an online game for a plurality of users and a computerized recommender system for providing recommendations to the online game, the recommender system comprising a high level recommender sub-system and a low level recommender sub-system, the high level recommender sub-system being configured to:

receive high level game activity data from the online game, wherein the high level game activity data is human readable data describing recently occurred in-game activity and is encoded low level game activity data;

generate high level recommendations based on the high level game activity data; and

export the high level recommendations to the online game;

the low level recommender sub-system being configured to receive low level game activity data from the online game, wherein the low level game activity data is low level data describing the recently occurred in-game activity; and

generate low level recommendations based on the low level game activity data;

the recommender system being configured to compare the low level recommendations from the low level recommender sub-system with the high level recommendations from the high level recommender sub-system, and if there is a low level recommendation that has no corresponding high level recommendation, output the low level recommendation that has no corresponding high level recommendation so that it can be encoded as high level activity data.

In this way the automated delivery of human readable in game recommendations can be expanded and adapted to fit the evolution of the online game. And the efforts of the development team can be focused on recommended content that will have the greatest impact across the population.

The high level game activity may comprise user actions, wherein each user action comprises one or more low level variable changes.

Both the high level recommender sub-system and the low level recommender sub-system may be trained to provide recommendations based on the same in-game activity.

In another aspect of the invention, there is provided a method for providing in game recommendations to users of an online game system, comprising:

receiving high level game activity data from the online game, wherein the high level game activity data is human readable data describing recently occurred in-game activity and is encoded low level game activity data;

generating high level recommendations based on the high level game activity data; and

exporting the high level recommendations to the online game;

receiving low level game activity data from the online game, wherein the low level game activity data is low level data describing the recently occurred in-game activity;

generating low level recommendations based on the low level game activity data; and

comparing the low level recommendations from the low level recommender sub-system with the high level recommendations from the high level recommender sub-system, and if there is a low level recommendation that has no corresponding high level recommendation, outputting the low level recommendation that has no corresponding high level recommendation so that it can be encoded as high level activity data.

The high level game activity may comprise user actions, wherein each user action comprises one or more low level variable changes.

Both the high level recommender sub-system and the low level recommender sub-system may be trained to provide recommendations based on the same in-game activity.

In a further aspect of the invention, there is provided an online game system comprising a computerized recommender system for providing user recommendations to one or more online game servers hosting an online game for a plurality of users, wherein the recommender system is configured to update a user's recommendations if and only if the user has used the online game since a most recent update.

In a still further aspect of the invention, there is provided a computerized online game system for hosting an online game for a plurality of users, comprising a game server and a computerized recommender system, the recommender system providing recommendations to the online game, wherein the game server is configured to use a recommendations data set comprising user specific recommendations for users of the online game to provide in-game recommendations to those users, wherein the recommender system is configured to export an updated user specific recommendations data set to the game server based on users' in-game activity, and wherein the game server is configured to switch from a current user specific recommendations data set to the updated user specific recommendations data set after the updated user specific recommendations data set has been exported to the game server.

This aspect of the invention ensures that the process of updating recommendations has minimal impact of the operation of the game and in particular on the experience of the users of the game.

The user specific recommendations data set may differ from the current user specific recommendations data set only for those users that have used the online game since the export of the current user specific recommendations data set.

It should be clear that features of the invention described in relation to one aspect may be applied to or combined with other aspects of the invention.

### BRIEF DESCRIPTION OF THE DRAWINGS

The invention will be described in more detail, by way of example, with reference to the accompanying drawings, in which:

FIG. 1 is a schematic illustration of an online game system in accordance with the invention;

FIG. 2 is a functional illustration of the recommender system of FIG. 1;

FIG. 3 illustrates the ingestion process of FIG. 2;

FIG. 4a illustrates the prepare, train and apply system of FIG. 2;

FIG. 4b is a flow diagram of the ingestion and data preparation processes;

FIG. 5a is a flow diagram of the training process of FIG. 2;

FIG. 5b illustrates a relationship between the features of a user and a location;

FIG. 6 is a flow diagram of the apply process of FIG. 2;

FIG. 7a illustrates a rule mining process in accordance with the invention;

FIG. 7b illustrates a rule mining process in accordance with the invention;

FIG. 8a is a schematic illustration of the process for delivery of recommendations to the user;

FIG. 8b is a flow chart illustrating the process for determining whether to deliver a recommendation to a user;

FIG. 9 is a screenshot of an example of a delivered recommendation;

FIG. 10 illustrates the system for the delivery of recommendation data from the recommender system to the game server;

FIG. 11a illustrates the process for updating the recommendation data in the online game;

FIG. 11b illustrates the merging of old and new player recommendation data;

FIG. 12 is an illustration of the evolution of the recommendation data over several update cycles;

FIG. 13 illustrates the encoding of low level variable changes into human understandable actions; and

FIG. 14 illustrates a system for automating the delivery of recommendations to users.

### DETAILED DESCRIPTION OF THE INVENTION

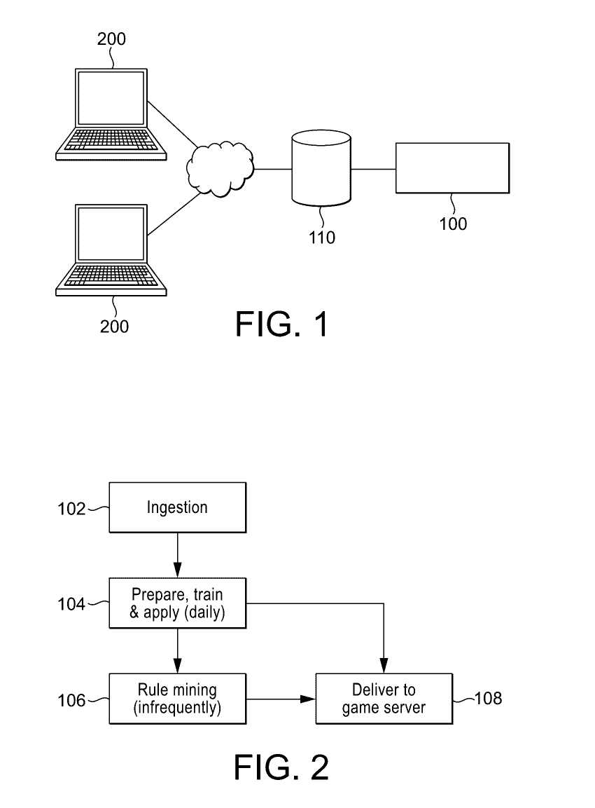

FIG. 1 is a schematic illustration of an online game system for a plurality of users. The system comprises one or more game servers 110 that host the online game. Users 200 connect to the game server 110 over a network, typically the Internet. A computerised recommender 100 system is connected to the game servers over a network and provides recommendations and recommendation rules to the game server to allow recommendations to be delivered to the users while they are playing the game.

An example computerized recommender system 100 for providing recommendations in an online game for a plurality of users will now be described with reference to FIGS. 2 to 14.

As illustrated in FIG. 2, broadly, the recommender system 100 is arranged to operate as follows. It includes an ingestion module 102 that ingests or has input into it information from the online game that is run on a game server. The game server stores player level log data. That is, information on activity of each player in the online game. The ingestion module inputs this information into a preparation, training and application module 104 that prepares, trains and applies a model to form personal recommendations for users of the online game and rules for triggering the delivery of recommendations. The preparation, training and application process is carried out daily. A rule mining module 106 mines the recommendations for the user of the online game received from the preparation, training and application module 104 to produce a set of rules that form in-game recommendation triggering rules. This mining process is carried out infrequently; less often than the preparation, training and application, such as weekly. The preparation, training and application module and rule mining module output their recommendations and rules to the game server, illustrated in block 108. The game server then delivers recommendations to the users of the online game 200 as the users or players play the game. All of these components are described in more detail below.

Overall, there is a general application of a recommender model to a population of users or game players to produce both personal recommendations and population wide rules for the triggering of those recommendations. The population wide rules are mined or reduced to provide a reduced set of rules based on the most commonly occurring events with the population wide data. The rules and recommendations are formulated off the game server on a separate computer arrangement and are periodically delivered to the game server where they are stored and used by the game server to deliver or provide recommendations in real time to the game players. In this way, processing capacity of the game server is not used to provide the recommendations and game play is not significantly or noticeably interrupted by the production of the recommendations.

The recommender system is implemented on a distributed storage and distributed processing system on clusters of computers on a separate computer system to the game server. The clusters are sets of computers that work together. Each cluster has a node or server. Each node performs the same task that is controlled and scheduled by software. In this example, the Apache Hadoop open-source software framework is used. The nodes process data in parallel. Data is sent to particular nodes and code is sent to the nodes with the required data for processing. In this example, the code is sent or shipped by Hadoop Map/Reduce. This orchestrates the processing by marshalling the distributed servers or nodes, running the various tasks in parallel, managing all communications and data transfers between the various parts of the system, and providing for redundancy and fault tolerance.

### Data Ingestion

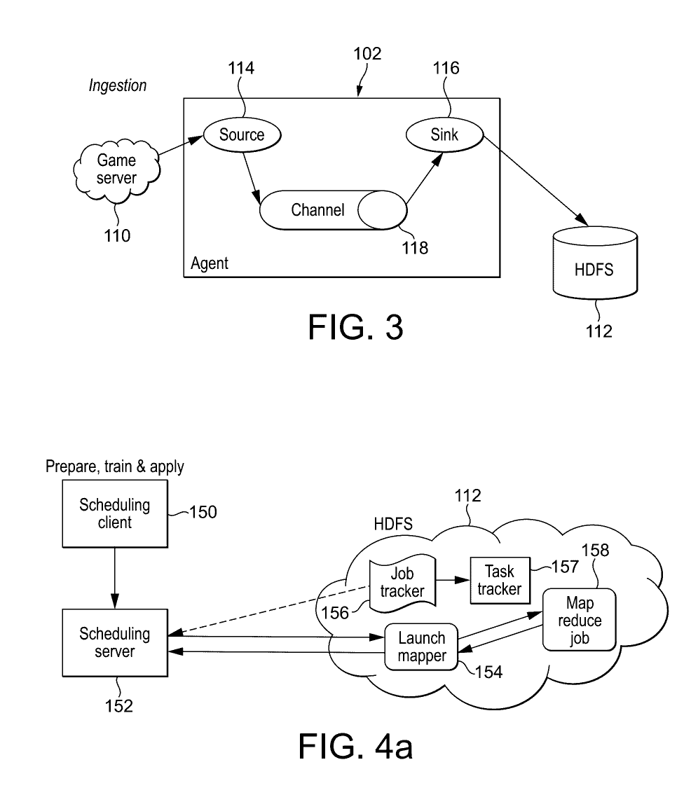

The ingestion module illustrated in FIG. 3a can be instantiated through the open-source Apache Flume framework and comprises an agent that collects data from the game server 110 and sends the data to a data store 112. The agent includes a source 114 and a sink 115 connected together for communication via channel 118. The source waits or listens for data to be delivered from the game server. When data is delivered from the game server to the source, the source passes the data to the sink via communication channel 118. The sink writes or is responsible for writing the data to the data store 112. In this example, the data store is a distributed file system. In the distributed file system, the data is split into blocks and distributed amongst nodes in the cluster. In this example, a Hadoop Distributed File System (HDFS) is used. In this way, player level data is obtained using a distributed data collection architecture.

### Preparing User Data for Generating Recommendations

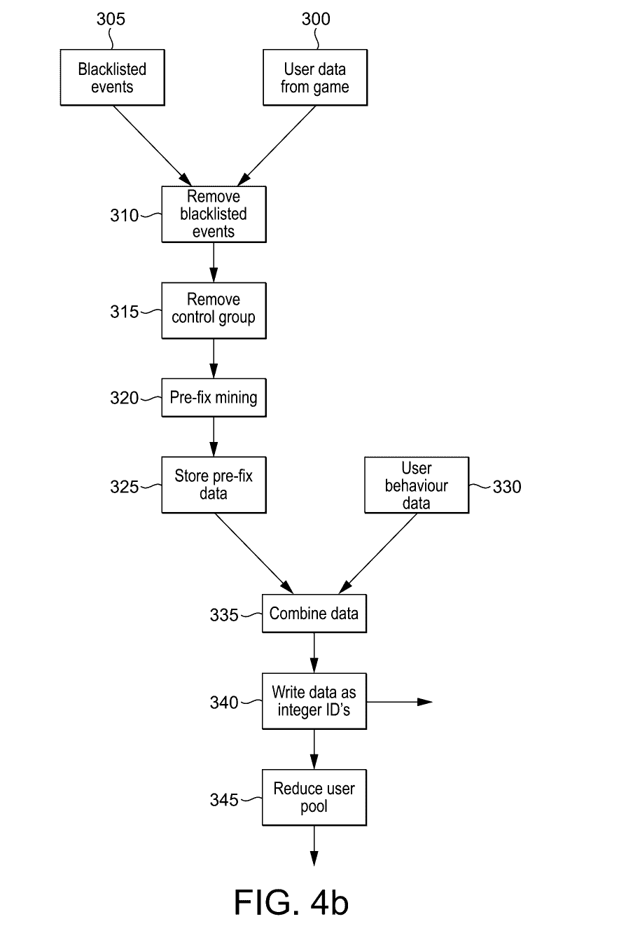

The preparation, training and application module 104 of FIG. 4a includes a scheduling client 150 and scheduling server 152. The scheduling client is in communication connection with the scheduling server. The scheduling server is in communication connection with a MapReduce engine that is located above the HDFS 112.

The MapReduce engine includes a JobTracker 156 and a TaskTracker 157. The Map Reduce job or Hadoop Map/Reduce job 158 is launched on the MapReduce engine via Launch Mapper 154 in response to a signal or instructions from the scheduling server 152.

The scheduling client 150 periodically (for example, daily) instructs the scheduling server 152 to begin the Hadoop Map/Reduce job 158 to implement the prepare, train and apply method of the recommender system described below.

The scheduling server 152 submits MapReduce jobs to implement the prepare, train and apply method to the JobTracker 156, which pushes out the work to available TaskTracker nodes 157 in the cluster, striving to keep the work as close to the data as possible. In the present example, the HDFS is a rack-aware file system and the JobTracker 156 knows which node contains the data as well as nodes that are physically close. If the work cannot be hosted on the actual node where the data is located, priority is given to nodes in the same rack. This reduces network traffic on the main backbone network. If a TaskTracker fails or times out, that part of the job is rescheduled. The TaskTracker on each node spawns a separate Java Virtual Machine (JVM) process to prevent the TaskTracker itself from failing if the running job crashes the JVM. A heartbeat is sent from the TaskTracker to the JobTracker 156 every few minutes to check its status.

All stages of the offline recommender system training and application happen with HDFS and are written as distributed Map Reduce Jobs. As described above, the task scheduler implemented on the scheduling client 150 schedules a daily update to run once all of the ingestion dependencies have been satisfied. It then monitors the running of the prepare, train and apply processes and re-launches any jobs that may have failed as indicated via the heartbeat sent from the TaskTracker to the JobTracker.

The ingestion and the data preparation method of the recommender system is shown in FIG. 4b. Player level user data is delivered to the recommender system from the game servers in step 300. This data ingestion is performed daily, and typically includes data from a particular time window, for example the previous seven days. A list of blacklisted events which are to be excluded from the data used by the recommender system to generate recommendations and recommendation rules is also sent from the game server in step 305. These events are typically events within the game that are not directly relevant to a specific user's activity. For example, a user may plant a seed in the game. Over the following days a plant may grow from the seed. Each time the plant increases in size it is an event within the game, but it is an event that is not related to a specific user's activity. This type of event is included in the list of blacklisted events. The blacklisted events are then removed from the user data in step 310. Optionally, in step 315, a control group of users and their associated data can be removed from the data that is used to generate recommendations. This control group can then be used later to provide a measure of the effectiveness of the recommender system in encouraging desirable user behaviour within the game.

In step 320, pre-fix span mining is performed on the remaining user data. In this step user actions within the data are divided into strings of actions, limited by time and location within the game, to form activities. For example, the string of actions of “get axe, chop wood, chop wood, gather wood” might be grouped into a single activity. Common activities are given a prefix, and only those common activities are taken forward for use in generating recommendations. This reduction in the size of the data set processed by the recommender system is critical for games played by many users, for long periods during a day. In step 325, each user's data in then stored in terms of the common activities identified in step 320.

The common activities are stored on a per user basis, covering the time period of the data ingested. The common activities are stored as a set of events carried out by a user, but they not stored in the order in which they were performed. They are instead stored as frequency values, i.e. how many times that activity was carried out in the time period, associated with a list of the common activities in a order that is used for all of the users' common activity data.

In addition to the user activity data, the recommender system determines whether each user has exhibited behaviour relevant to the recommender system in the time period. In other words, if the recommender system is configured to promote in-game purchases, then for training the recommended system it is useful to provide information about which users exhibited the desired behaviour by making an in-game purchase. This information is provided in step 330 and is typically a binary value. Either the user exhibited desirable behaviour in the relevant time period or they did not.

In step 335 the user behaviour data from step 330 is combined with the user activity data so that the frequency of particular user activities and the associated relevant user behaviour is known for each user. Inferences about which particular activities are associated with desirable user behaviour can then be made by the training model, as described below.

In step 340, the size of the data set is reduced by replacing all distinct elements remaining in the data set with integer IDs for computational efficiency.

In step 345, the data set taken forward for training is reduced still further. In step 345, only highly active users are retained by removing all users whose activity data is a subset of another user's activity data within the data set.

The output from step 345 is the training data set that is provided for training the recommender system. The training data is provided periodically to the training module, in this example, daily. The training data includes locations in the game where users visit and sequences of actions carried out by the users at the locations they visit.

### Recommendation Model

The training model is applied to the training data set output from step 345 to provide personal recommendations for each of the users in the data set, i.e. recommendations particular to each user that are likely to promote desirable user behaviour, such as, time in-game or spend in-game.

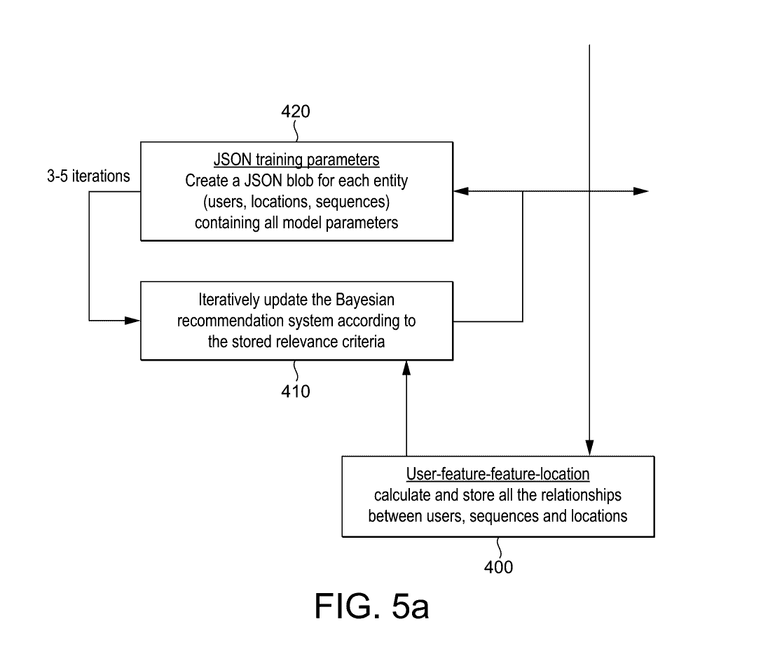

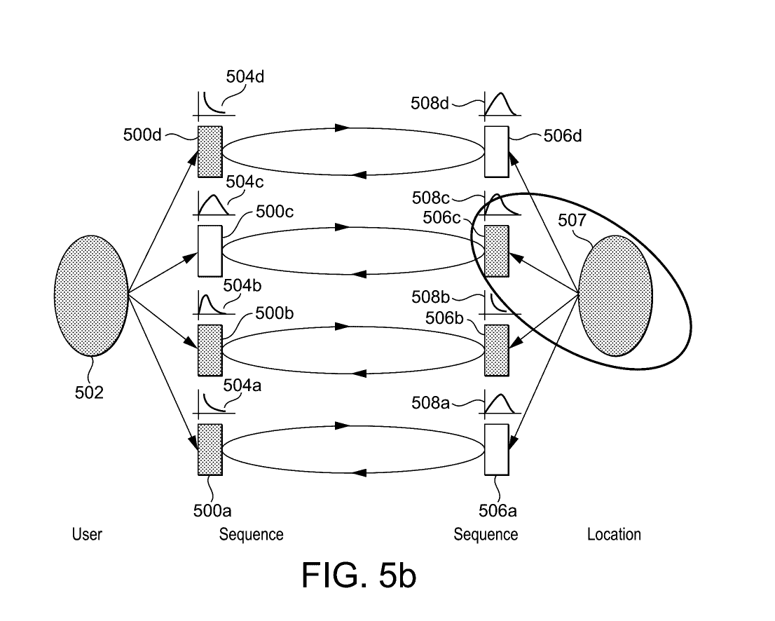

The training data is provided to a Bayesian inference calculator illustrated in FIG. 5a. The Bayesian inference calculator calculates locations and actions at those locations that are most likely to lead to a most desirable outcome. An indication of the locations and actions at those locations that are most likely to lead to a most desirable outcome is described in a predetermined data format in the form of JSON (Javascript Object Notation). This is a data format that is in human-readable text. That is, it is possible for humans to read and write. It is also easy for computers to parse or analyse and generate. In this way, the recommendation model can easily be integrated into an online game by human computer programmers.

FIG. 5a illustrates the training process carried out by the training module. In step 400 the training data is received. Each user is defined by a set of features or sequences based on their past activities and locations visited and each location within the game is defined by a set of features or sequences based on the activities that can be performed there. All relationships between users, sequences and locations are calculated and stored in the computerized recommender system.

The relationships between the features of each user and each location are established in step 410. This is illustrated in more detail in FIG. 5b. Each sequence of actions 500a, 500b, 500c, 500d by a user 502 has a probability distribution 504a, 504b, 504c, 504d associated with it. The probability distribution or mathematical distribution function may be, for example, a Poisson distribution. Each sequence of actions 506a, 506b, 506c, 506d at a location 507 has a probability distribution 508a, 508b, 508c, 508d associated with it. This probability distribution may also be, for example, a Poisson distribution. The strength of the relationships or, in other words, the mutual preference between feature or sequence pairs is determined based on the initially stored relevance criteria mentioned above. The stronger the connection between the features of a user with the features of a particular location, the more desirable it is to recommend that location to the user. Combining the probabilities of a user carrying out a sequence of actions, the mutual preference or bidirectional connection between users carrying out certain actions and those certain actions being carried out at a particular location and the probabilities of a sequence of actions being carried out at a particular location provides a set of recommended locations for each player. Referring now back to FIG. 5a, in step 410, the Bayesian inference calculator iteratively fits the parameters to try to best satisfy this combination. Each parameter of the calculator or model is iterated separately. Significantly, the iteration comprises no more than 3 to 5 iterations of each parameter. In addition, each total fitting is carried out periodically, in this example, only once per day. This is a surprisingly low number of iterations. As a result, it is quick and computationally efficient to fit the parameters.

In this example, the model is that defined in Gorla, J 2014, A Bi-directional Unified Model for Information Retrieval. Ph.D. thesis, University College London incorporated herein by reference. However, the model may be a collaborative filtering model of the type described above.

The features used to define the users and locations can have more desirable and less desirable distributions, which capture the desirability of a feature. In this way, in-game locations may be recommended to users.

However, the inventors of the present application have appreciated that recommending solely in-game locations does not provide a sufficient level of resolution as there are many possible activities that may be carried out by a user at any given location. To overcome this, one option is to create a large number of sequence-location pairs for all combinations. However, this creates a very large number of recommendable entities which requires significant computational resource to examine. As an alternative, the inventors of the present application have appreciated an embodiment following a three-step process. The process or method is as follows.

Identify a set of recommended locations for each player as described above.

Rank the sequence features possessed by each location according to the strength of their bidirectional connection to the player features or mutual preference plus the player's desirability for each feature. This captures the notion that players of that type will go on to exhibit the desired behaviour at that location if they engage with that content.

Select a number or plurality of sequences, according to the ranking, for each location for that player or each single user.

Any combination of features can be refined into or defined as a single overarching entity to produce a drastically smaller set of entities for the model to operate over. This optimisation allows the system to draw recommendations from significantly larger inventories, but with modest computing resources.

FIG. 5a, at step 420, illustrates that the selected, ranked sequences are then written to or created in JSON as a so-called JSON blob, which is an object of data in JSON for each entity. That is, the iteratively fitted model parameters for each user, location and sequence are created and stored in the computerized recommender system in JSON. The sequences, or sets or groups of sequences may be generalised.

In this way, at least one recommendation is provided to each single user based on the ranking that may include an activity or sequence of activities for the user to carry out in-game at a particular location.

### Personalised Recommendations

The output of the training module from step 420 is used to provide both personalised recommendations and rules for triggering the delivery of recommendations. For each user, a ranked list of recommendations is generated from the training model, with those recommendations that have the highest relevance to the user, i.e. are considered to be most likely to produce a desired outcome, placed at the top of the list. Each recommendation consists of an in game location and an activity at that location. For example, “go to the forest and chop some wood”.

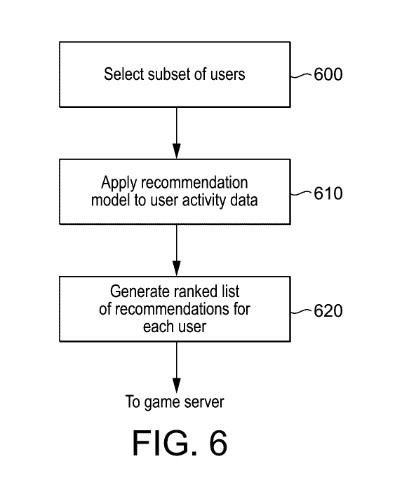

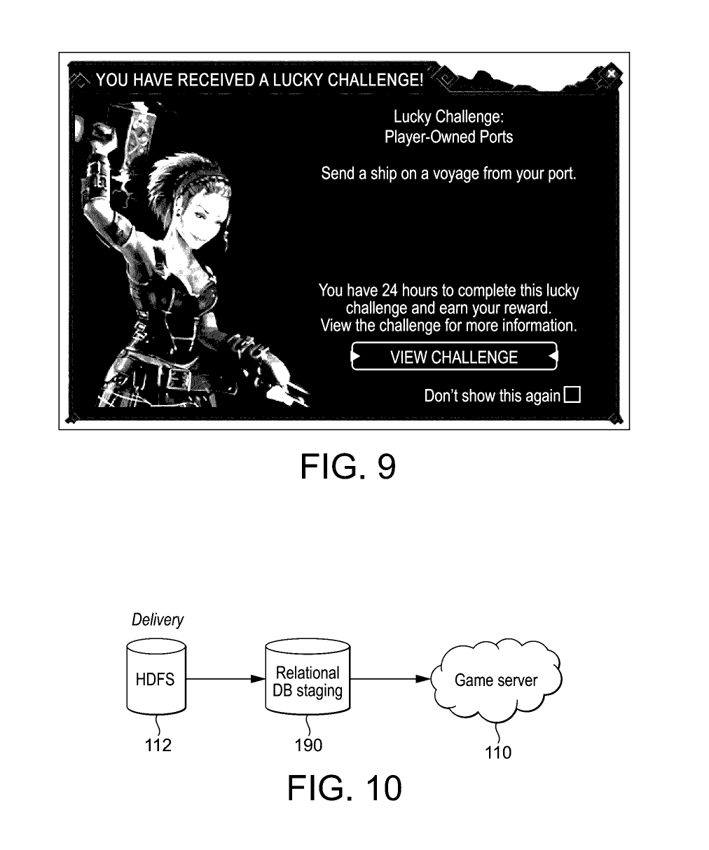

FIG. 6 illustrates the process of generating personalised recommendations using the training model. This process is carried out daily. In a first step 600, a subset of users from the user data output from step 340 may be selected for receiving recommendation for that day. For example, 10% of users may be selected to receive recommendations. This ensures that data processing requirements are manageable and ensures that user's are not constantly bombarded with recommendations each day. By selecting only a small portion of the total users, users are more likely to be seen as lucky or privileged to receive recommendations. In a preferred embodiment, recommendations are delivered to the users as “lucky challenges”, as described below with reference to FIG. 9.

In a second step 610, the output from the training model from step 420 is applied to the activity data from the selected users to generate a plurality of recommendations for each selected user based on their recent game activity. Each user is defined by a set of features based on their recent game activities, together with relevance criteria as explained. A location/activity pair is selected as a recommendation for a user if that location/activity pair has a strong connection to the features defining that user. This is a two stage process in which in one step the model is applied to the user data from step 340 to provide recommended locations and in a another step the model is applied to the user data from step 340 to provide recommended activities. The locations and activities are then combined to provide location activity pairs. In step 620, a ranked list of personal recommendations is assembled for each user in a database that can be exported into the game server.

Each individual's daily personalised recommendation list is contained in a final table which is written to a relational staging database before being loaded by the game server when the relevant individual logs onto the game.

### Recommendation Triggers

In addition to personal recommendations for each user, the recommender system produces a set of population-wide recommendation rules which determine which user activities can trigger a particular recommendation. These population wide, or generic, rules are extracted from the recommendations made by the training model together with the user data from the game server.

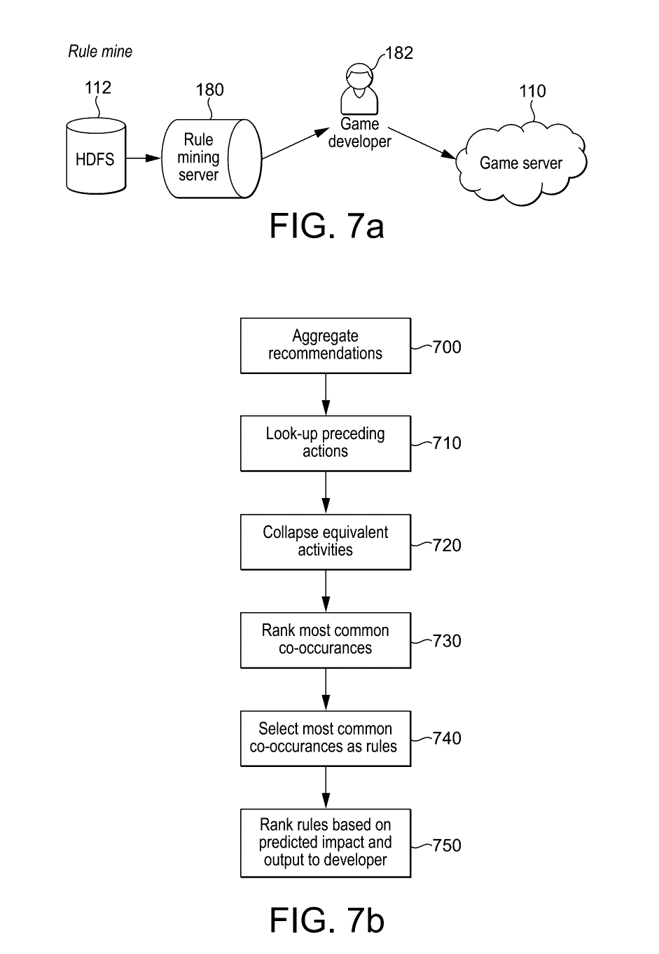

As illustrated in FIG. 7a, rule mining occurs infrequently and externally to the HDFS 112. Periodically, a static dump, placement or copy of the user level data stored on the HFDS is made from the HDFS to a rule mining server 180. This user level data covers a particular time window, for example 14 days. The mining process described below runs on the rule mining server and produces inferred low-level recommendation trigger conditions. These inferred low-level recommendation trigger conditions are then provided to and interpreted by a (human) game developer 182 and encoded into a player friendly form on the game server 110. As illustrated in FIG. 7a, by using a game designer to interpret and encode each rule we can ensure that the recommendations fit within the requirements of the game and are delivered so that players would find them comprehendible.

The formation of generic, population-level mined rules is achieved by aggregating observed actions and subsequent recommendations at the population level, identifying and encoding the most frequent co-occurrences within the game. FIG. 7b schematically illustrates the process of rule mining. To mine the rules each player is defined by two components, their own set of personalised recommendations from the application of training model provided in step 420 and the observed actions that preceded each recommendation within the user activity data provided from the game server. In a first step 700 all the user recommendations from step 620 in FIG. 6 for the whole population of users are aggregated. Then, in step 710, actions that preceded those recommended actions within the user activity data are then extracted from the user activity data from the game server. The co-occurrences of recommendation and preceding action that occur most frequently within the population, i.e. occasions where a specific action is followed by a specific recommended action, are identified and ranked in step 730. The recommendations are generated according to specific target outcomes, e.g. revenue increase or game time optimisations, so each individual will be recommended the content that leads to the most favourable change in their behaviour. By then aggregating these favourable changes and selecting the most frequent the population rules will have the largest possible impact.

When determining what counts as a specific action each player's continuous event stream is segmented according to location and time. If a player changes location within the game or a specified time elapses then we consider the preceding set of activities to be a specific action. The order of events within each segment is disregarded, so that segments containing the same events in a different order are regarded as equivalent. This process is carried out before the most common co-occurrences are identified and ranked and is illustrated as step 720. This step dramatically reduces the processing required.

The most common co-occurrences are taken forward as triggering rules for use within the game in step 740. The rules operate such that when a user takes one of the actions preceding a recommendation in the rules, the corresponding recommendation may be provided to the user. In order to maximize their impact upon the game these rules are ranked according to their predicted impact on the population, including consideration of the frequency of their co-occurrence within the population in step 750. Those with the highest ranking are chosen to be interpreted and encoded within the game, by a developer, to deliver meaningful recommendations that fit within the bespoke mechanics of the specific game. Low level game events expressed as variable changes cannot be meaningfully delivered to a player directly as they would be incomprehensible.

### Delivery of Recommendations

Having been derived these rules can then trigger recommendations to any player who meets the activity trigger conditions.

Once one of the rules provided in step 750 has been triggered within the game, the recommendation associated with the triggered rule is compared in real time with the ranked list of personalized recommendations for the user that triggered the rule, provided in step 620. If the triggered population level recommendation is also present on the individual user's personalized recommendation list, then the recommendation is delivered to the user. This ensures that delivered recommendations are both relevant to current in game activity and personal to individual player behavior.

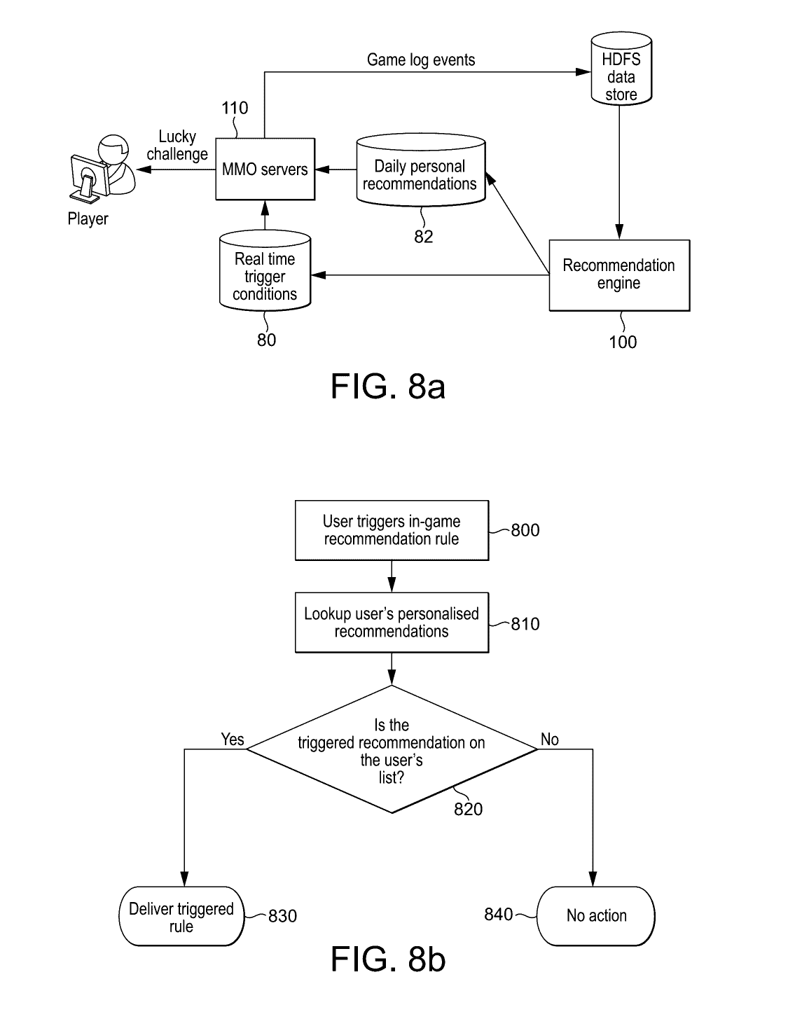

FIG. 8a is a schematic of the game system as it delivers recommendation to a user. The recommender system 100 provides both recommendation rules or trigger conditions 80 and daily personal recommendations 82 to the game severs 110. The game servers 110 use this information to provide recommendations to the user. At the same time user activity data is recorded and exported to the HDFS data store, and can then be used to train the recommendation system to provide new recommendation and trigger conditions.

FIG. 8b illustrates the delivery of recommendations that are tailored to each individual playing the game. In step 800 a user triggers a recommendation rule. In step 810 the user's personalized recommendation list is looked-up. In step 820 it is determined whether the triggered recommendation is on the user's personalized recommendation list. If the triggered recommendation is on the user's personalized recommendation list, then in step 830 the recommendation is delivered. If the triggered recommendation is not on the user's personalized recommendation list then no action is taken, as illustrated by step 840.

FIG. 9 illustrates an example of a recommendation delivered to a user as a “lucky challenge” in a pop-up window. The user can choose to view the details of the recommendation by clicking on the “view challenge” link or can choose to ignore the recommendation by closing the pop-up window.

### Export of Recommendation Data to Game Servers

The delivery of both personalized recommendations and the recommendation rules must be achieved with minimal impact on the playing experience of the online game. Massively multiplayer online games are typically played by players located worldwide and there is significant user activity 24 hours a day. There is no game downtime during which updates and fixes can be loaded. It is also desirable that the personalized user recommendations are maintained up-to-date even when users have an irregular activity pattern.

FIG. 10 is a schematic illustration of the general export process. Recommendations from HDFS system 112 which hosts the recommender system are first loaded into a staging environment to minimize performance impact on the live game. The staging environment is a relational database 190. Once the data is ready, it is then imported into the live game by a transactional switch of the database from the last export to the newly prepared database. This switching between databases prevents the game from using recommendations for mere milliseconds.

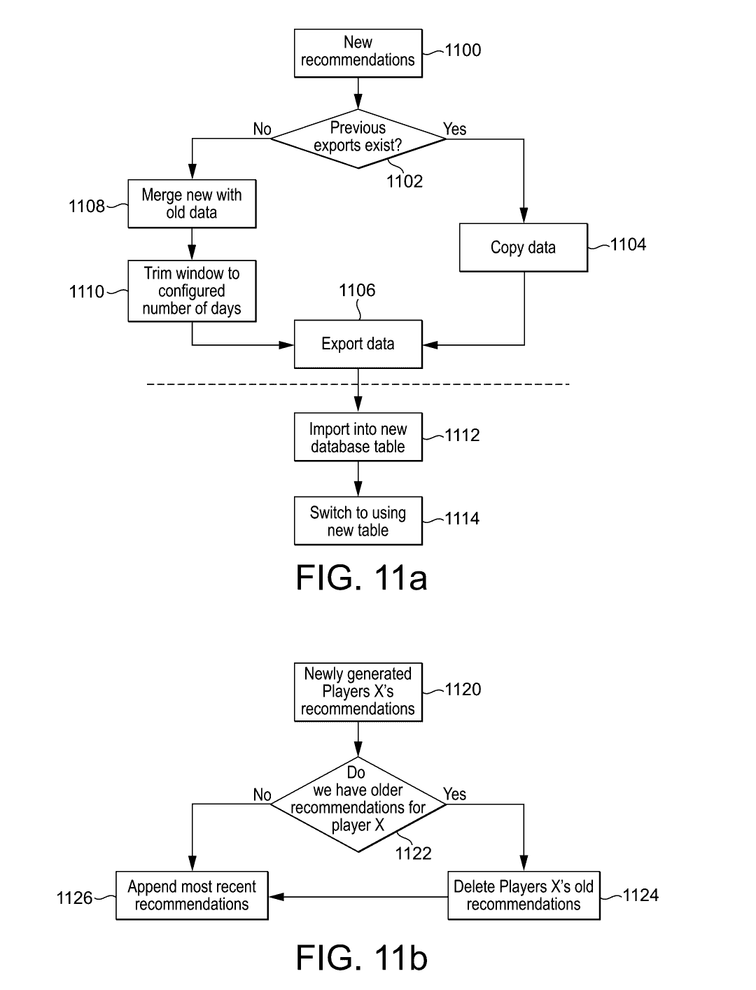

FIG. 11a illustrates in more detail the preparation of the recommendation data for export. Newly generated recommendations are merged into those generated during previous runs. The data export system starts once player action data has been analyzed and subsequent recommendations have been generated, shown as step 1100. In step 1102 it is determined whether previous exports of recommendation data exist. If not, the new recommendation data is copied into a database in step 1104 ready for export to the game servers in step 1106.

If there are previous recommendation exports then the new recommendation data are merged with the old recommendation data in step 1108. This is done or a per user basis. FIG. 11b illustrates this merging process in more detail. The newly generated recommendations for a particular user are provided in step 1120. In step 1122 it is determined whether, for this particular user, there are existing recommendations. If there are existing recommendations for the user, the existing recommendations are deleted in step 1124 and the most recent recommendations are then added in step 1126. If there are no existing recommendations, then the process proceeds directly to step 1126, in which the new recommendations are added.

Returning to FIG. 11a, after step 1108 in which the new data is merged with the old data, the process proceeds to step 1110. In step 1110, the recommendation data is trimmed by date. Each personalized recommendation has an associated date of creation. Recommendations older than, for example, one month, are discarded. The recommendation is then copied into a database ready for export to the game servers in step 1106.

The recommendation database is exported into the live game once per day. The database is first imported onto the game server in step 1112. The game server then switches to the new recommendation database from the previous database in step 1114. At the end of this process, for each player there are the most up to date recommendations available since they last played the game.

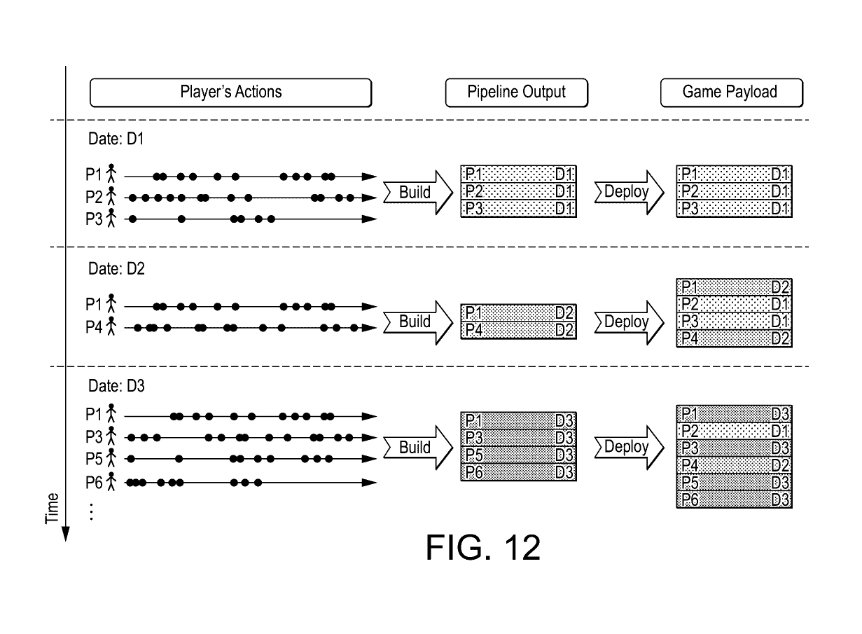

FIG. 12 illustrates the merging process over 3 successive data exports taking place over three days, D1, D2 and D3 for six players P1, P2, P3, P4, P5 and P6. On day D1 players P1, P2 and P3 play the game and recommendations are generated for them based on their game activity. These recommendations are exported to the game of day D1. On day D2 only players P1 and P4 play the game and recommendations based on their game activity generated. These recommendations are merged with the recommendations generated on day D1. In the merging process player P1's previous recommendation is replaced by a new recommendation. On day D3 players P1, P3, P5 and P6 play the game and recommendations are generated based on their game activity. These new recommendations are merged with the previous recommendations for players P2 and P4 and then exported to the game. In this way each player is provided with the most up-to-date personalized recommendations based on their recent game activity.

### Automated Recommendation Delivery

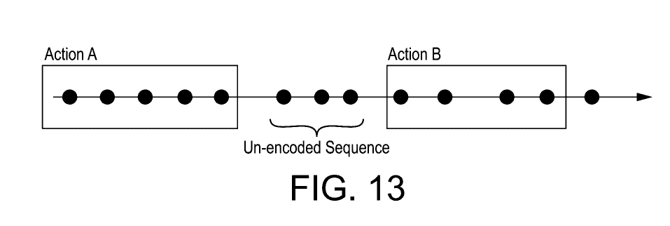

In the system described so far, it is necessary for a developer to interpret recommendation data from the training module to turn largely human incomprehensible low level variable changes into human readable content. By logging in-game events in a way that is atomic, human readable and player suitable to each new piece of content, the recommendation system can automatically expand to deliver these new game actions without developer intervention. To achieve human readability and player suitability, low level variable changes are grouped and mapped to atomic game events which represent these collections of level actions. FIG. 13 illustrates a sequence of user variable changes in a game, each circle representing a low level variable change. Some of these variable changes are grouped together and treated as a single user action, which is a human understandable action. This is done once only by a game developer. The recommender system is trained on and uses the human readable actions.

As players incidentally trigger these human readable actions they provide a training set for the recommendation system. Once the recommendation system has been trained on these human readable actions, it can be used to deliver personalized recommendations to users without an intermediate, human driven, rule encoding step.

The following is an example of an encoded action comprising several low level variable changes:

### Action Header

### Id: 1

### Recommendable: True

Description: “Go, brave warrior and chop down 20 trees.”

### Requirements: Woodcutting Level>20

Variable changes: Equip axe, swing axe, swing axe, collect wood

### Location: Forest (20,34)

This system can be expanded by operating a parallel system using the raw variable change data, as described, to inform the game developer which actions need to be encoded in a human readable format. The recommendations from the parallel system are not pushed to the live game but act as a check on the first system which uses human readable actions. As each structured human readable action has an associated set of variable changes, the “raw” low-level variable-driven recommendations can be compared to the human readable recommendations. If the “raw” recommender system begins to produce recommendations that cannot be found within the human readable recommendations then the developer can encode new actions that can be recommended in human readable form to remedy the deficit.

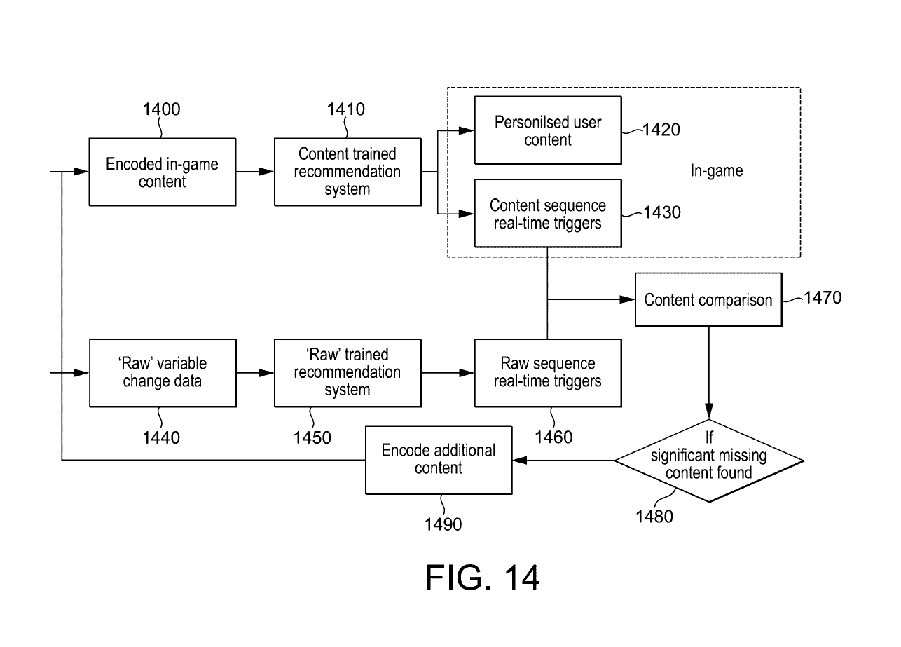

FIG. 14 illustrates this process. The high level or human readable recommender system 1410 is provided with human readable encoded content 1400. The recommender system 1410 generates both personalized user recommendations 1420 and rules 1430 for triggering the delivery of those recommendations, as previously described. These recommendations and rules are automatically delivered to the online game. Simultaneously, a low level recommender system 1450 is provided with low level variable change data 1440. The low level recommender system generates rules 1460 for triggering the delivery of recommendations based on the low level variable change data 1440. The human readable rules 1430 are compared with the low level rule 1460 in block 1470. This comparison may be carries out automatically in software or may be done by a developer. If the low level recommender system 1450 is found to be producing rules that are not being generated by the human readable recommender system and that would lead to significant delivery of in game recommendations, then the game developer is able to determine which low level variables need to be encoded into to high level, human readable actions in order for the human readable recommender system 1410 to be able to generate the missing recommendations. In this way the automated delivery of in game recommendations can be expanded and adapted to fit the evolution of the online game.

Embodiments of the present invention have been described. It will be appreciated that variations and modifications may be made to the described embodiments within the scope of the present invention.

1. An online game system configured to provide at least one recommendation in an online game for a single user of a plurality of users of the online game, comprising:
a computerized recommender system configured to rank, based on desirability of at least some of the plurality of users' past behavior within the online game, mutually preferred sets of sequences of in-game activities previously carried out by at least some of the plurality of users of the online game and sets of sequences of in-game activities available at locations within the online game;
wherein the online game system provides at least one recommendation of an in-game activity to a single user, based upon the desirability rank of that activity sequentially following prior activities of the single user, as ranked by the computerized recommender system.

2. An online game system according to claim 1, wherein the desirability of the plurality of users' past behavior comprises at least one of: time in-game by the plurality of users and spend in-game by the plurality of users.

3. An online game system according to claim 1, wherein the at least one recommendation comprises at least one location for the user to go to in-game.

4. An online game system according to claim 1, wherein the at least one recommendation comprises at least one activity for the user to carry out in-game.

5. An online game system according to claim 1, wherein the sets of sequences of in-game activities comprise generalized sets of sequences of in-game activities.

6. An online game system according to claim 1, wherein each user has an associated set of user features, wherein the at least one recommendation comprises a set of recommended in-game locations, and wherein the system is configured to provide a ranking of sequences of in-game activities associated with each recommended location according to the mutual preference between the sequences of in-game activities associated with each recommended location and the set of user features for the single user, and to select a plurality of sequences of in-game activities according to the ranking to provide a set of location-activity sequence pairs for the single user.

7. An online game system for a plurality of users, comprising one or more game servers hosting an online game and a computerized recommender system connected to the one or more game servers for providing recommendations in the online game;
the computerized recommender system being configured to:
for each of a plurality of recommended actions, determine preceding user actions that lead to that recommended action to generate a set of user action/recommendation pairs;
produce a reduced set of user action/recommendation pairs from the set of user actions by removing user action/recommendation pairs having an equivalent action/recommendation pair within the set of user action/recommendation pairs; and
identify the most frequently occurring user action/recommendation pairs from those user action/recommendation pairs within the reduced set of user action/recommendation pairs to form a set of rules for providing recommendations within the online game;
the one or more game servers being configured to deliver recommendations to users of the online game based on the set of rules and on actions taken by the users within the online game.

8. An online game system according to claim 7, wherein the user actions comprise sets of user events, and wherein the computerized recommender system is configured to categorise user actions comprising the same user events in different order as equivalent user actions.

9. An online game system according to claim 7, wherein the computerized recommender system is further configured to:
rank the rules in the set of rules based on predicted impact of the recommendation in the online game;
select highest ranked rules; and
output the selected highest ranked rules as a set of generic rules for the online game.

10. An online game system according to claim 9, wherein the one or more game servers are configured to:
compare a single user's actions with the set of generic rules and if the user's actions correspond to one of the generic rules, provide a generic recommendation corresponding to that generic rule;
compare the generic recommendation with a ranked list of recommendations for the single user; and
deliver to the user the generic recommendation if it is also present in the ranked list of recommendations for the single user.

11. An online game system according to claim 7, wherein the recommender system is configured to export an updated user specific recommendations data set to the game server based on users' in-game activity, and wherein the game server is configured to switch from a current user specific recommendations data set to the updated user specific recommendations data set after the updated user specific recommendations data set has been exported to the game server.

12. An online game system according to claim 11, wherein the updated user specific recommendations data set differs from the current user specific recommendations data set only for those users that have used the online game since the export of the current user specific recommendations data set.

13. An online game system configured to providing recommendations in an online game to a single user of a plurality of users of the online game, wherein the game system is configured to:
compare a ranked list of recommendations for the single user with a generic recommendation taken from a list of generic recommendations for the plurality of users; and
deliver the generic recommendation if it is on the ranked list of recommendations for the single user.

14. An online game system according to claim 13, wherein the ranked list of recommendations for the single user is based on recent activity of the single user in the game.

15. An online game system according to claim 13, wherein the ranked list of recommendations for the single user is ranked based on predicted impact within the game.

16. An online game system according to claim 13, wherein the computerized recommender system is further configured to:
provide the generic recommendation based on the single user's actions within the game.

17. An online game system according to claim 13, wherein the recommender system is configured to update the ranked list of recommendations for the single user if and only if the single user has used the online game since a most recent update.

18. An online game system according to claim 13, wherein the recommender system is configured to export an updated user specific recommendations data set to the game server based on users' in-game activity, and wherein the game server is configured to switch from a current user specific recommendations data set to the updated user specific recommendations data set after the updated user specific recommendations data set has been exported to the game server.

19. An online game system comprising a game server hosting an online game for a plurality of users and a computerized recommender system for providing recommendations to the online game, the recommender system comprising a high level recommender sub-system and a low level recommender sub-system, the high level recommender sub-system being configured to:
receive high level game activity data from the online game, wherein the high level game activity data is human readable data describing recently occurred in-game activity and is encoded low level game activity data;
generate high level recommendations based on the high level game activity data; and
export the high level recommendations to the online game;
the low level recommender sub-system being configured to receive low level game activity data from the online game, wherein the low level game activity data is low level data describing the recently occurred in-game activity; and
generate low level recommendations based on the low level game activity data;
the recommender system being configured to compare the low level recommendations from the low level recommender sub-system with the high level recommendations from the high level recommender sub-system, and if there is a low level recommendation that has no corresponding high level recommendation, output the low level recommendation that has no corresponding high level recommendation so that it can be encoded as high level activity data.

20. An online game system according to claim 19, wherein the high level game activity comprises user actions and wherein each user action comprises one or more low level variable changes.
